(19) United States
(12) Patent Application Publication
(10) Pub. No.: US 2005/0209937 A1
(43) Pub. Date: Sep. 22, 2005

(54) Methods, systems, and storage mediums for providing web-based reporting services for telecommunications entities

(76) Inventors: Marcee Burns, Marietta, GA (US); Michael Guillory, Decatur, GA (US)

Correspondence Address: CANTOR COLBURN LLP, 55 GRIFFIN ROAD SOUTH, BLOOMFIELD, CT, 06002, US

(21) Appl. No.: 10/801,845

(22) Filed: Mar. 16, 2004

(51) Int. Cl. G06F 17/60

(52) U.S. Cl. 705/30

(57) ABSTRACT

Exemplary embodiments relate to methods, systems, and storage mediums for providing web-based reporting services to a telecommunications entity. The method includes providing a user interface to a client system in response to a request for a report which includes a report type. A requester is provided with a template and enters request data therein. Upon receiving the request data, a database is searched for a dataset corresponding to the request data. If the dataset is found, an order is retrieved from the database in accordance with a requested report type, budget data relating to the order is retrieved, a report using the order and the budget data is compiled, and the report is made available to the requester over a web-based network. The report includes a cost driver and/or a timeliness driver. Report types include cost reports, timeliness reports, telecommunication equipment order preparation reports, driver reports, and custom search reports.

### BACKGROUND OF INVENTION

The present invention relates generally to telecommunications systems and services, and more particularly, to methods, systems, and storage mediums for providing web-based reporting services for telecommunications entities.

Many telecommunications service industries today perform a variety of business processes in addition to providing telecommunications services to its customers. Given the advancements in communications technologies such as wireless, broadband, and the like, many service providers outsource some of their business processes such as engineering, equipment installation, maintenance, and other types of services to outside vendors and contractors. Coordinating and tracking the activities (e.g., engineering, installation, maintenance, and billing) between services provided by in-house personnel and those performed by outsourced entities can be cumbersome. What is needed is a reporting and tracking system for managing these activities.

### SUMMARY OF INVENTION

The above-stated shortcomings and disadvantages are overcome or alleviated by the reporting system of the invention.

Exemplary embodiments relate to methods, systems, and storage mediums for providing web-based reporting services to a telecommunications entity. The method includes providing a user interface to a client system in response to a request for a report which includes a report type. A requester is provided with a template and enters request data therein. Upon receiving the request data, a database is searched for a dataset corresponding to the request data. If the dataset is found, an order is retrieved from the database in accordance with a requested report type, budget data relating to the order is retrieved, a report using the order and the budget data is compiled, and the report is made available to the requester over a web-based network. The report includes a cost driver and/or a timeliness driver. Report types include cost reports, timeliness reports, telecommunication equipment order preparation reports, driver reports, and custom search reports.

A system for providing web-based reporting services to a telecommunications entity includes a host system in communication with at least one client system via communications network, the host system comprising a server and a data repository storing databases of budget data and order data. The server executes web server software, a budget tool, and an ordering tool. The system also includes a user interface accessible to the client system. The user interface includes templates for entering report request data by a user of the client system. The server receives a request for a report, provides a requester with a template only if the requester is authorized to receive the report, and prompts the requester to enter request data in the template. Upon receiving the request data, the server searches a database for a dataset corresponding to the request data. If the dataset is found, the server retrieves at least one order from the database in accordance with a report type requested. If the dataset is not found, the server returns an error message to the requester. The server retrieves budget data related to the order and compiles a report using the order and the budget data. The report includes a cost driver and/or a timeliness driver. The server then makes the report available to the requester over a web-based network.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF DRAWINGS

Referring now to the drawings wherein like elements are numbered alike in the several FIGURES:

FIG. 1 is a block diagram of a system upon which the reporting system may be implemented in exemplary embodiments;

FIG. 2 is a flowchart describing a process for implementing the reporting system in exemplary embodiments;

FIG. 3 is sample user interface main menu screen as seen by a user of the reporting system in exemplary embodiments;

FIGS. 4A-4D are sample model reports prepared via the reporting system in exemplary embodiments;

FIGS. 5A and 5B are sample cost reports prepared via the reporting system in exemplary embodiments;

FIG. 6 is a listing of data available for use in preparing costs reports by the reporting system in exemplary embodiments;

FIGS. 7A and 7B are sample timeliness reports prepared via the reporting system in exemplary embodiments;

FIG. 8 is a sample TEO preparation report prepared via the reporting system in exemplary embodiments;

FIGS. 9A and 9B are sample driver reports prepared via the reporting system in exemplary embodiments;

FIGS. 10A-10C are sample custom model part search reports prepared via the reporting system in exemplary embodiments; and

FIG. 11 is a listing of data available for use in preparing timeliness reports by the reporting system in exemplary embodiments.

### DETAILED DESCRIPTION

The reporting system of the invention relates to a web-based query and reporting tool that works from the data tables of an ordering tool. Report options include summarization by ordered item counts, engineering and installation expenditures and timeliness, billable order work efforts, service activity quantities and costs, and quantification of custom orders. Each of these options support and provide monitoring for key measurements including financial and timeliness indicators. The reporting system enables an enterprise to quantify purchase levels for various types of equipment/major material/capital items, engineering and installation costs, as well as related minor material costs. The reporting system further enables an enterprise to quantify and to consistently and mechanically reproduce measurements for establishing current performance levels and set targets for improvement.

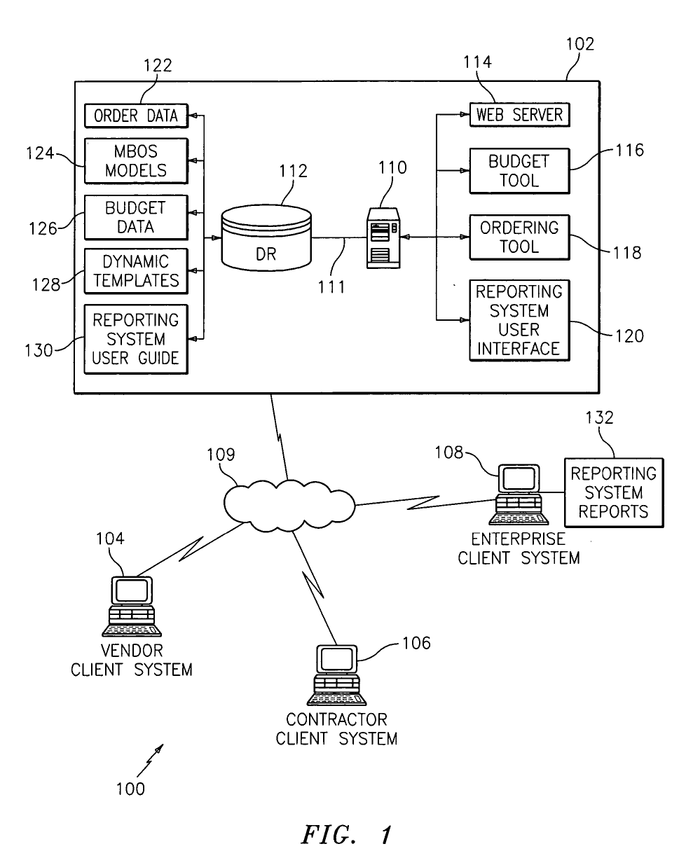

FIG. 1 depicts a system 100 upon which the reporting system may be implemented in exemplary embodiments. System 100 includes an enterprise host system 102 (also referred to herein as ‘host system’), a vendor client system 104, a contractor client system 106, an enterprise client system 108, and a communications network 109.

Host system 102 refers to a telecommunications service provider such as a telephone company, a cable company, a wireless Internet or telephone service provider, or other similar type of provider. Host system 102 includes a server 110 and data repository 112 coupled together via a communications cable or network 111. In alternate embodiments, server 110 and data repository 112 may comprise a single unit such as, for example, a high-powered mainframe computer.

Server 110 includes a web server 114 for transmitting web pages to outside entities, a budget tool 116, an ordering tool 118, and a reporting system user interface 120 (also referred to herein as ‘user interface’). Budget tool 116 refers to an accounting application that tracks expenditures and account codes related to orders placed in the system. Budget tool 116 may comprise a commercial application or may be a proprietary product specific to the enterprise executing the reporting system. Ordering tool 118 refers to an application used to create, process, store, and execute orders for engineering services, installation services, equipment, components, and project-based. Ordering tool 118 may comprise a commercial off-the-shelf application or may be the ordering tool described in patent application Ser. No. 10/648,751 entitled “Method, System, and Computer Program Product for Facilitating the Telecommunication Equipment Ordering Process”, which was filed on Aug. 25, 2003 by the Assignees of the instant application and is incorporated herein by reference in its entirety. The subject application standardizes the equipment ordering and provisioning processes across various departments for telecommunications industries. The ordering tool of the subject application further interacts with, and gathers data from, existing applications to support the ordering of equipment and services. The equipment orders may identify the services for engineering, installation, minor material items, major material items and costs. Once completed, the equipment orders are then made available to purchasing agents.

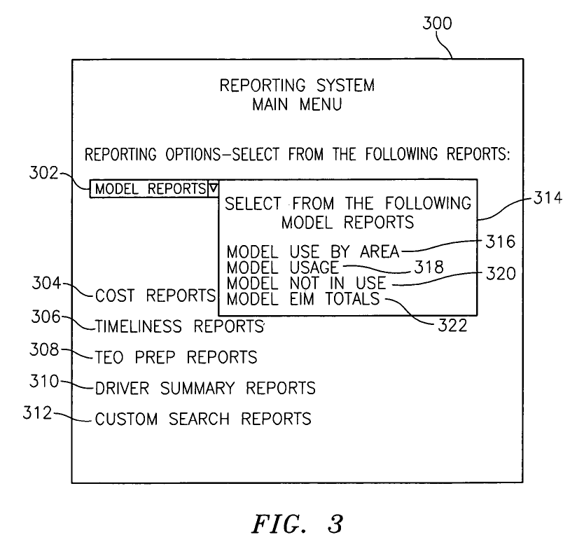

The reporting system further includes a user interface 120 for facilitating the execution of the processes described herein, a sample of which is shown generally in FIG. 3.

Data repository 112 may be implemented using a variety of devices for storing electronic information. It is understood that data repository 112 may be implemented using memory contained in server 110 or it may be a separate physical device. Data repository 112 is logically addressable as a consolidated data source across a distributed environment that includes networks 111 and 109. The physical data may be located in a variety of geographic locations depending on application and access requirements. Information stored in data repository 112 may be retrieved and manipulated via host system 102.

Data repository 112 includes order data database 122, and model based ordering system database 124, budget data database 126, dynamic templates 128, and a reporting system user guide 130. Order data may include hardware, software, equipment, components, and/or service orders (also referred to herein as telecommunication equipment order records/orders). Project records may also be stored in order database 122. Further, each project record may correspond to one or more telecommunication equipment order (TEO) records and each TEO record may correspond to one or more detail records. MBOS models database 124 stores data relating to the transmission network serviced by host system 102, budget data database 126 stores data related to expenditures and account codes for orders, and reporting system user guide 130 provides guidance to users of the reporting system in implementing its features and functions.

Vendor client system 104 refers to an entity that supplies host system 102 with equipment and/or components for equipment. Contractor client system 106 represents an entity to which host system 102 has outsourced its services. For example, contractor client system 106 may represent an engineering company, an installation business that performs equipment and service installations, and/or a maintenance organization that maintains and repairs equipment. It will be understood that the services provided by client systems 104 and 106 may overlap in that, for example, vendor client system 104 may provide equipment to host system 102 and also perform installation of the equipment.

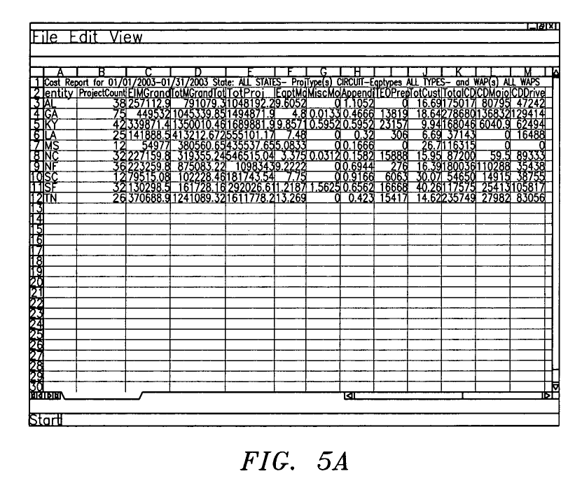

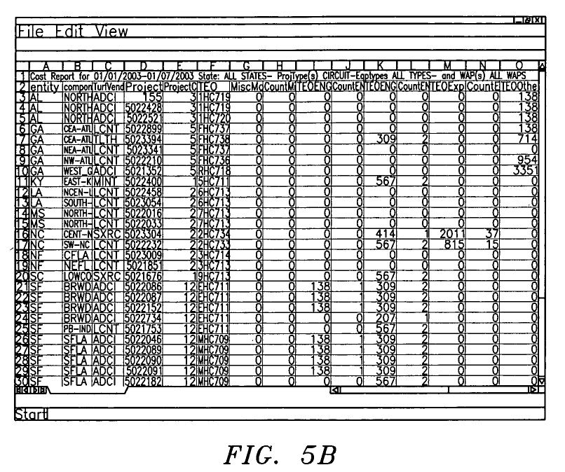

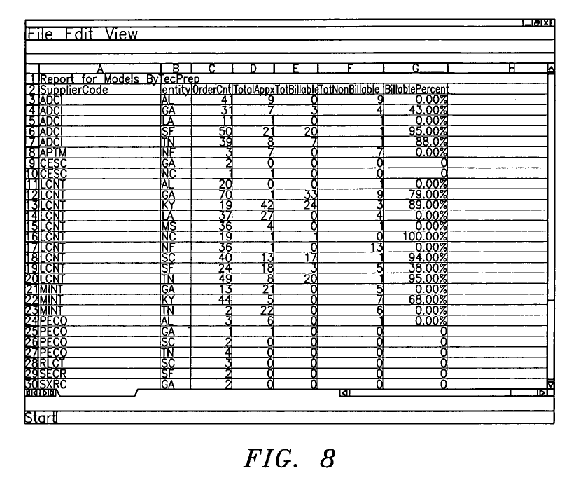

Enterprise client system 108 refers to a representative of host system 102, such as a remote office facility. In exemplary embodiments, client system 108 refers to a state capacity management organization of host system 102. Client system 108 accesses host system 102 and receives various reports 132 via execution of the reporting system. Additionally, client systems 104 and 106 may also have access to the reporting system features and functions, typically on a limited access basis. Sample reports available through the reporting system are illustrated in FIGS. 5, and 7-10.

Each of client systems 104-108 may be implemented using a web-enabled, general-purpose computer executing a computer program for carrying out the processes described herein. Client systems 104-108 may be personal computers (e.g., a lap top, a personal digital assistant) or host attached terminals. If one or more of client systems 104-108 are personal computers, the processing described herein may be shared by the respective client system and host system 102 (e.g., by providing an applet to the client system).

Client systems 104-108 may be in communication with host system 102 via network 109. Network 109 may be any type of known network including, but not limited to, a wide area network (WAN), a local area network (LAN), a global network (e.g. Internet), a virtual private network (VPN), and an intranet. Network 109 may be implemented using a wireless network or any kind of physical network implementation known in the art. One or more of client systems 104-108 may be coupled to host system 102 through multiple networks (e.g., intranet and LAN) so that not all client systems 104-108 are coupled to host system 109 through the same network. One or more of client systems 104-108 and host system 102 may be connected to network 109 in a wireless fashion.

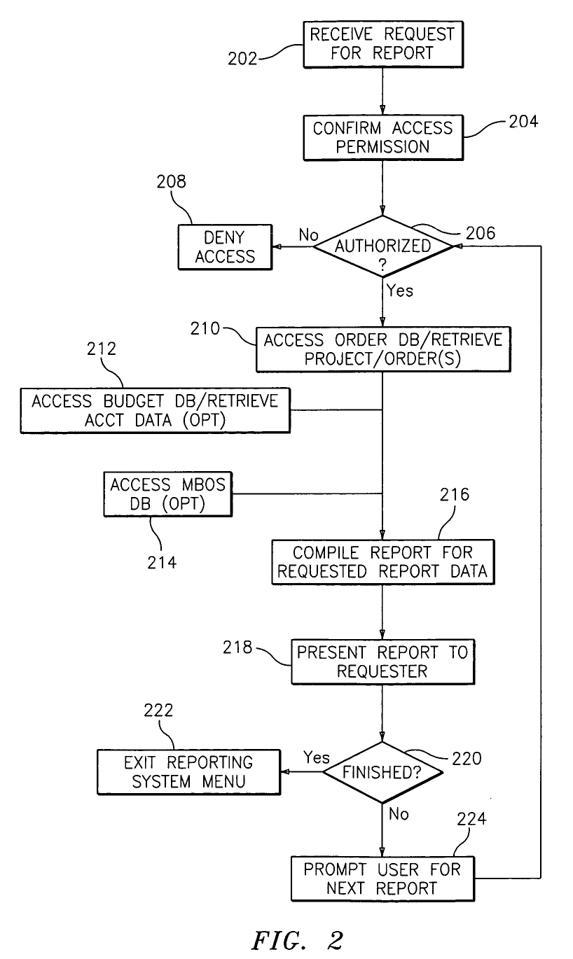

Turning now to FIG. 2, a process for implementing the reporting system will now be described. A user at one of client systems 104, 106, or 108 accesses the reporting system via a web browser application. A request for a report is received by host system server 110 via reporting system user interface 120 at 202. A sample user interface screen is shown generally in FIG. 3. The reporting system checks to see if the user has access permission for the type of request received at 204. This may be accomplished in a secure fashion using an encryption tool or other security feature that requires users to enter a user identification and password. If the user is not authorized to access the particular reporting component at 206, the reporting system denies the user access at 208. Otherwise, the reporting system provides the requester with a template from dynamic templates database 128 that is directed to the type of report requested and prompts the user to fill in the items listed in the template. Once the items have been submitted over the web to host system 102 by the requester, the reporting system accesses order database 122 and looks for a dataset in the database that corresponds to the requested data provided in the template. If a match is found, the reporting system retrieves one or more orders stored therein in accordance with the user's request at 210. If no match is found, the reporting system returns an error message to the requester. The reporting system further accesses budget database 126 and retrieves budget data related to the orders and/or projects associated with the orders at 212. If the user has requested a MBOS report, the reporting system accesses MBOS database 124 and retrieves network building data at 214.

Using the data retrieved in steps 210, 212, and optionally 214, the reporting system compiles a report for the requester at 216 and transmits it via the web to the respective client system at 218. At 220, it is determined whether the requester has requested another report. If not, the reporting system main menu is exited at 222. Otherwise, the user is prompted to select another report from the main menu of user interface 300 at 224 and the process returns to 206. The requester may require further permissions screening at 206 because it is possible that while the requester may have permission to access one type of report, he/she may not be authorized to view other types of reports.

As indicated above, the reporting system enables authorized requesters at client systems 104-108 to access reports relating to telecommunications equipment orders and projects. Various types of reports are available via the web using the reporting system as shown in the main menu of user interface screen 300 of FIG. 3. Once a user has accessed the reporting system web site, the main menu appears on the requester's screen. Available reports are organized into six main categories: model reports 302, cost reports 304, timeliness reports 306, TEO reports 308, driver summary reports 310, and custom search reports 312. As shown in FIG. 3 for illustrative purposes, a user has selected model reports 302. The reporting system presents a pop-up window 314 that displays all of the model reports (316-322) in model reports category 302. These reports 316-322 are shown in FIGS. 5A-5D, respectively.

Model report option 302 provides reporting functions that reflect items (e.g., services, equipment, components) ordered for any given period of time based upon the classification of the item, the item itself, or all the items overall for a supplier of the item, for a certain critical date. As indicated above, MBOS models provide a broad itemization of the building of the enterprise transmission network. The reporting system enables reporting on these models for a period of time, by vendor, by category, by usage, by non-usage, by associated engineering/installation/minor material (EIM) costs, and by major material costs.

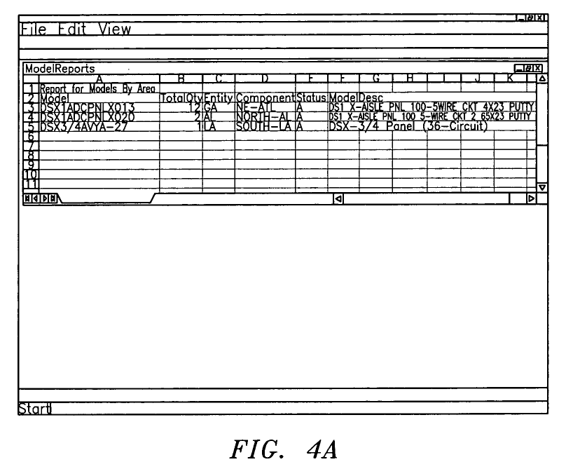

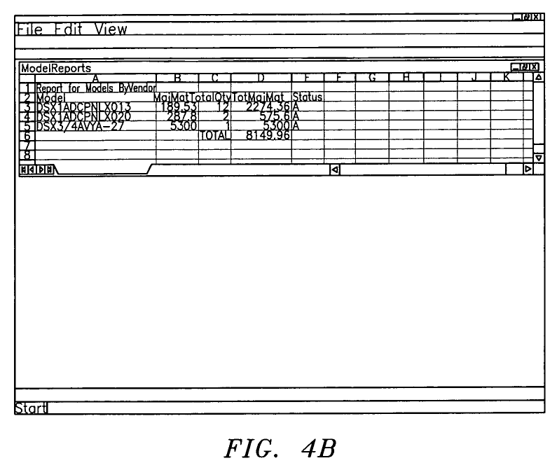

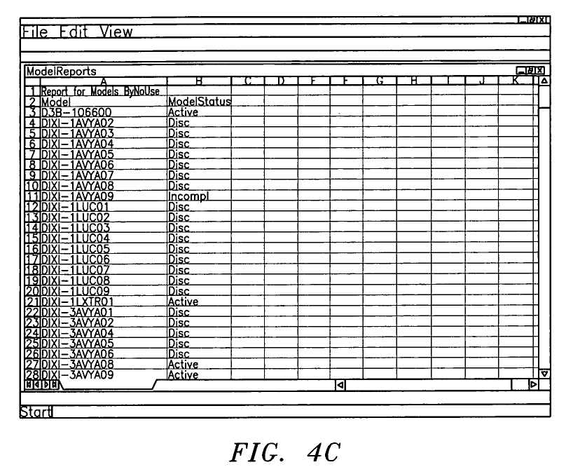

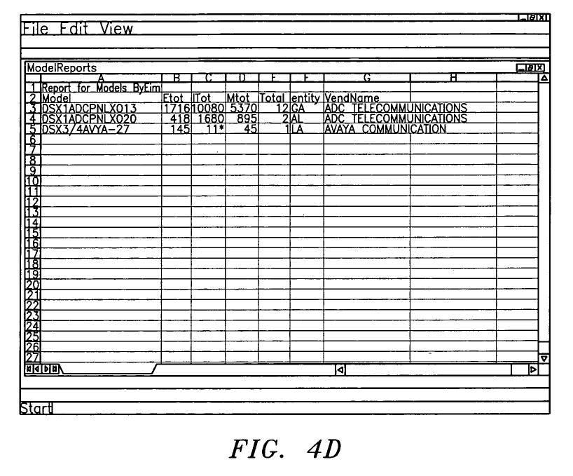

FIG. 4A illustrates a sample Model Use by Area report 400A. This report produces a count of the model usage at the component or district level in accordance with the particular model selected by a requester (e.g., DSX). Information provided in report 400A includes model name 402, total quantity of models used 404, entity 406 (e.g., state), component 408 (district), model status 410, and model description 412.

FIG. 4B illustrates a sample Model Usage Report 400B. Report 400B provides an overall count of the usage in accordance with the model selected. Report 400B further classifies the information according to vendor. The information available in report 400B includes model name 414, major material costs (e.g., unit cost for each model) 416, total quantity ordered during the time period selected 418, total expenditures per model 420, model status 422, and total expenditures per category 424 (not shown).

FIG. 4C illustrates a sample Models Not in Use report 400C for category DSX. Report 400C provides a list of the models that were not ordered during a time period selected by the requester. The information available in report 400C includes model name 426 and model status 428. Status information provided in column 428 includes active, discontinued, and incomplete.

FIG. 4D illustrates a sample Model EIM Totals report 400D for category DSX. Report 400D produces a list of the models with the dollar value of the detailed engineering, installation, and minor material costs for each model. Information available in report 400D includes model name 430, detailed engineering total dollars for the quantity (i.e., not unit cost) 432, total installation dollars for the quantity (i.e., not unit cost) 434, minor material total cost for the quantity (i.e., not unit cost) 436, total quantity ordered during the time period selected by a requester 438, entity (e.g., state) 440, and supplier/vendor of the model equipment 442.

FIGS. 5A and 5B represent two cost reports available via the reporting system. There are three benchmark measurements (i.e., cost drivers) that may be viewed and analyzed by a requester via the cost reports: in-place cost factors for EIM activities, custom detail costs/project dollars, and miscellaneous costs that do not fall into the categories associated with the first two drivers. In-place cost factors refer to the total costs for an order or project including any labor. Custom detail costs refer to those costs that do not conform to the standard costs associated with the more common enterprise activities. Many businesses have standard pricing systems for common or frequent purchases/services. Custom detail costs occur when one or more of an engineering/installation service and equipment purchase is out of the norm. This driver is directed to understanding how much spending occurred for custom work compared to the average cost of a given project. Standard installations may include installing a bay, setting up a shelf, or running a cable. Miscellaneous costs refer to any service or equipment item that cannot be categorized using the first two drivers above. FIG. 5A illustrates a sample Summary Cost Report 500A for a requested state and FIG. 5B illustrates a sample Detail Cost Report 500B for a requested state. Summary cost reports provide an average and/or total for all fields selected in the report request. Detail cost reports provide a line-by-line itemization for each project for all fields selected in the report request.

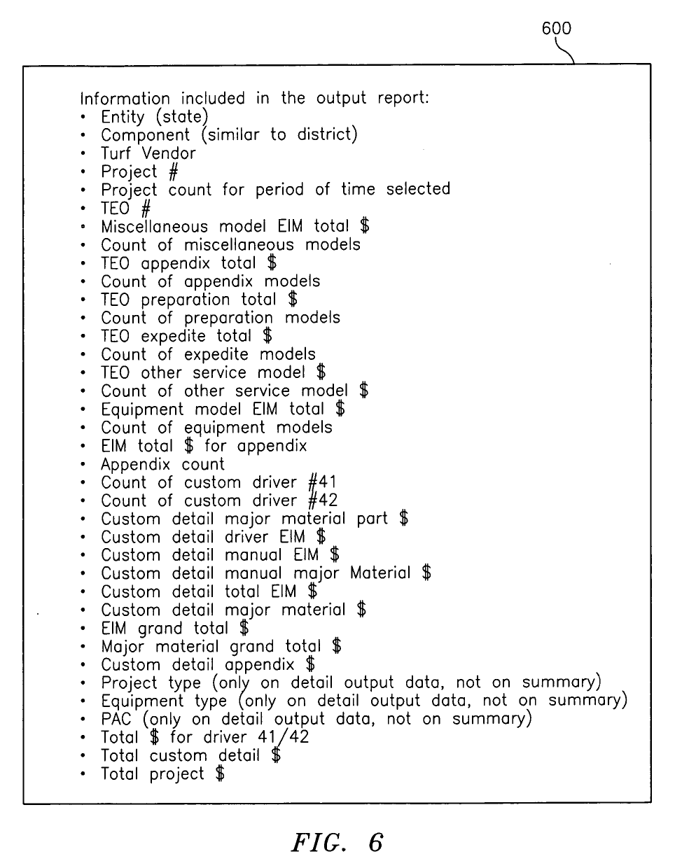

Information available in cost reports 500A and 500B are provided in FIG. 6. Reports 500A and 500B illustrate only a portion of the available data that is shown in FIG. 6. Cost reports may be sorted or grouped by vendor, and equipment type for a state level requester while additional parameters for sorting and grouping may be available to regional users.

Cost drivers are measured using the cost reporting features of the reporting system. For example, parameters enabled by the system allow a requester to measure the average amount of expenditures that are covered on a custom detail as a percentage of the total amount expended on a project as a whole. This information may be useful in assessing the viability and utility of the custom work being performed by or on behalf of an enterprise. Other information available using the cost report feature includes measuring the in-place costs (engineering, installation, and minor material) of major material. The total amount of modeled and non-modeled EIM charges per project will be divided by the total cost of the major material that was placed into service. Further, a requester may measure the total quantity of driver 41 and driver 42 used on custom detail by multiplying these items by unit cost of engineering/installation, followed by dividing the result by the total amount of the project.

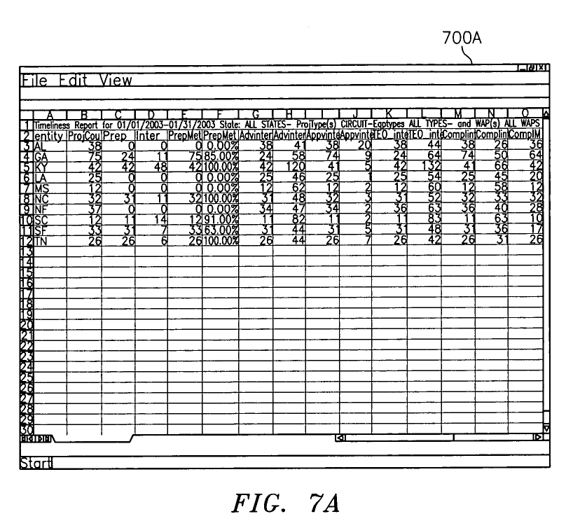

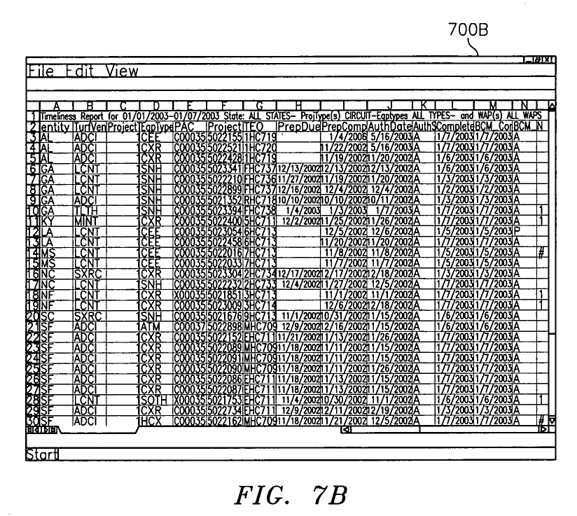

FIGS. 7A and 7B illustrate sample timeliness reports available via the reporting system. Timeliness reports provide useful information concerning the overall ordering, engineering, and installation processes that transpire between an enterprise such as host system 102 and its vendors and contractors. There are three timeliness drivers measured using the reporting system: turnaround times, advance notice intervals, and completion dates met. Turnaround times refer to the time taken to respond to a general request. Advance notice intervals refer to the amount of advance notice given to a party for performing an activity. For example, a complex project should allow for adequate advance notice in order to fairly assess the performance of the acting party, who may need to order supplies, schedule personnel, etc. Simple activities may require less advance notice. Completion dates met refers to the measure of performance relating which contractors/vendors/in-house personnel met their required completion dates.

Information in timeliness reports may be provided by equipment requests, order processing, order execution, and similar activities. Equipment requests refer to general requests for estimates or work from an outside party such as an engineering group, an equipment vendor, or installation service. When host system 102 sends an equipment request to one of these parties, it expects that the receiving party will respond in a timely manner with details, costs, etc. for the request. This activity can be measured using the timeliness reports of the reporting system.

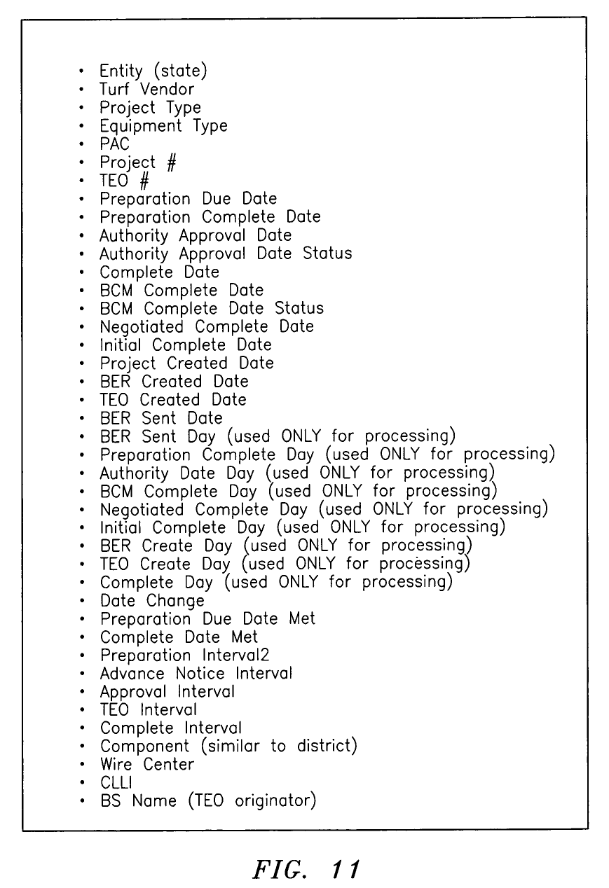

Information available in timeliness reports is shown in FIG. 11. A sample summary timeliness report is shown in FIG. 7A. A sample detail timeliness report is shown in FIG. 7B. Timeliness reports may be sorted by state, by state/vendor, by vendor, and by equipment type. Summary timeliness report 700A provides an average and/or total for all fields selected in the request. Detail timeliness report 700B provides a line-by-line itemization for each project for all fields requested in the report.

TEO preparation reports 800 are also available using the reporting system. TEO preparation reports may be utilized to review the overall percentage of projects containing appendices that are billable, by vendor, during the period of time in review. Information provided in TEO preparation reports include supplier code (e.g., vendor) 802, entity (e.g., state) 804, order count 806, total number of appendices 808, total number of billable appendices (e.g., those containing a TEOAPPX appendix preparation MBOS model charge) 810, total number of non-billable appendices (those appendices for which an enterprise was not billed an appendix preparation charge) 812, and billable percentage of appendices 814.

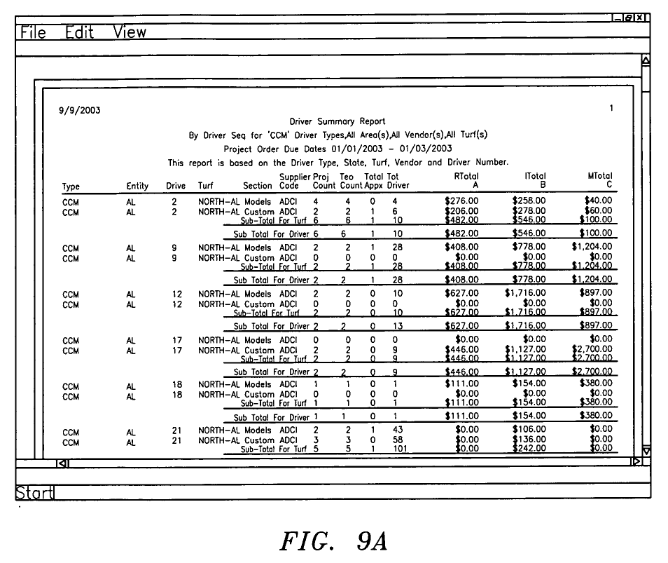

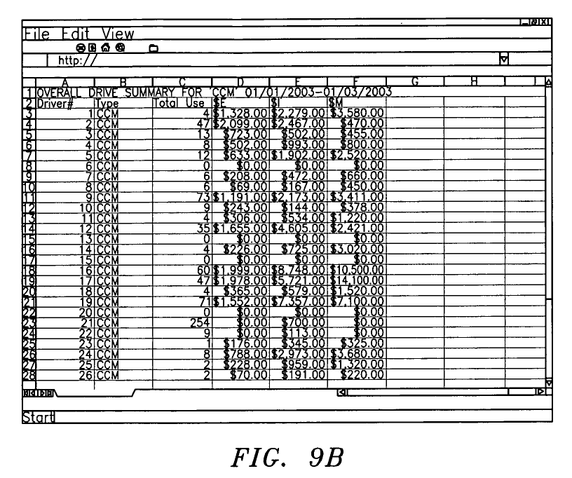

Driver summary reports are available using the reporting system as shown in FIGS. 9A and 9B. These reports are preferably limited to regional users. Users of the reporting system request reports by driver type. Drivers represent unit costs for a combination of applicable detailed engineering, installation, and minor material costs. They are generally service related, but may also include or represent minor material only. Driver types include circuit capacity management primary central office provisioning and maintenance work (CCM), central office space conditioning work (CO-COND), central office removal work (CO-Removal), work activities for standby engines (engine), unit cost for miscellaneous non-depreciable material items (minor material), outside plant work for customer premises, controlled environment vaults (CEV)s, and remote terminals (RTs) (collectively OSP), and work activities related to power provisioning and maintenance (power).

Driver summary report 900A reflects model usage at a detailed level by area. Information available in driver summary report 900A include driver type 902, entity (state) 904, driver ID number 906, district (e.g., turf) 908, use (e.g., custom detail or model) 910, turf vendor (e.g., supplier code) 912, project count 914, TEO count 916, total number of appendices 918, total number of occurrences of driver 920, total detailed engineering costs for driver (not unit costs) 922, total installation costs for driver 924, total minor material costs for driver 926, and grand totals 928 (not shown).

Overall driver summary report 900B reflects aggregated total model usage during the requested period of time and also reflects the related dollar expenditures for that driver. Information available in overall driver summary report 900B includes driver number 930, driver type 932, total usage count 934, total detailed engineering costs for driver 936, total installation costs for driver 938, and total minor material costs for driver 940.

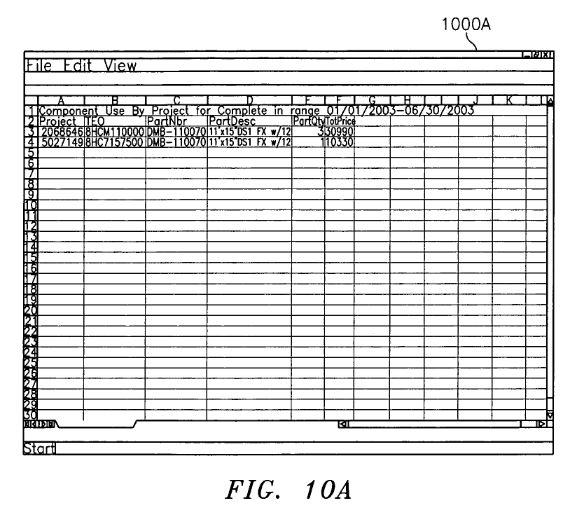

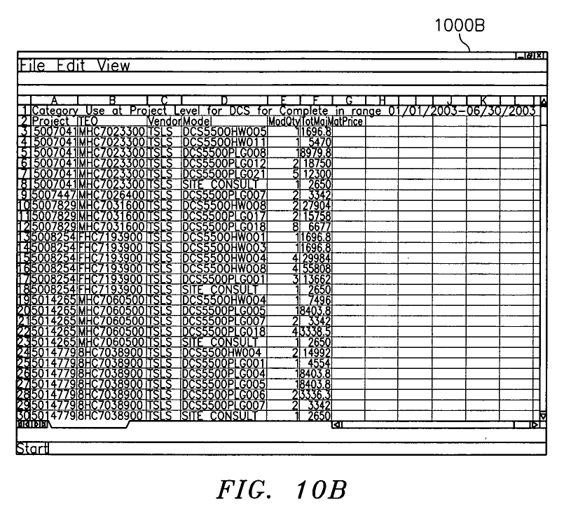

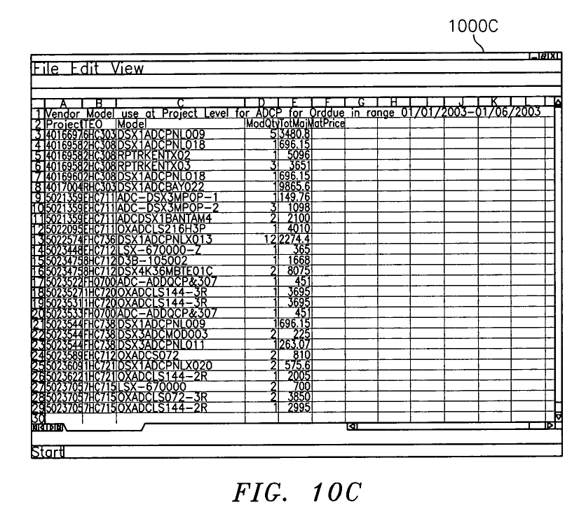

The reporting system enables a requester to execute a custom search report as shown in FIGS. 10A-10C. Custom search reports may be utilized to identify usage at various levels including a project level, with the project and TEO number reported. This information may be useful in identifying where certain equipment may be deployed or for working with suppliers to provide supporting details that will validate purchase levels. FIG. 10A illustrates a sample custom model part report 1000A for component use. Report 1000A enables a requester to identify usage levels of individual components (i.e., part numbers) and their possible respective use on the custom details of an order. Four methods may be used to search and report on component use as described herein. A category and specific component method is used to select a component from NBOS tables based first upon a category, and then upon an actual component. A specific component method may be used to select a component by performing a wildcard search for a portion of a part number or an entire part number, in the ordering tool's 118 component fields. A custom detail item description method may be used to select a component by performing a wildcard search for a portion of a part number or an entire part number in the custom detail description field. Also, a custom detail dollars exceeding method may be used to report on items which are above the designated budget amount.

A custom model part search report 1000B for category use is shown in FIG. 10B. Report 1000B may be used to identify usage levels of individual models within an entire MBOS equipment category. A custom model part search report 1000C for vendor use is shown in FIG. 10C. Report 1000C may be used to identify usage levels of individual models within an entire MBOS supplier code and produces results for a single supplier across all categories.

As can be seen from the above, the reporting system provides the capability to enable measurement setting and process monitoring for telecommunications industries. It allows users to select reports for all aspects of the ordering, engineering, and installation processes within, and external to, an enterprise via the Web.

As described above, the present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

1. A method for providing web-based reporting services to a telecommunications entity, comprising:
providing a user interface to a client system in response to a request for a report, said report specifying a report type;
providing a requester with a template only if said requester is authorized to receive said report;
prompting said requester to enter request data in said template;
upon receiving said request data, searching a database for a dataset corresponding to said request data;
if said dataset is found, retrieving at least one order from said database in accordance with a report type requested;
if said dataset is not found, returning an error message to said requester;
retrieving budget data related to said at least one order;
compiling a report using said at least one order and said budget data;
wherein said report includes at least one of a cost driver and a timeliness driver; and
making said report available to said requester over a web-based network;
wherein said report type comprises at least one of:
a cost report;
a timeliness report;
a telecommunication equipment order preparation report;
a driver report; and
a custom search report.

2. The method of claim 1, further comprising:
retrieving model-based ordering system data when said report type is a model report; wherein said compiling a report using said at least one order and said budget data includes compiling a report using said model-based order system data.

3. The method of claim 1, wherein said cost driver includes at least one of:
in-place cost factors operable for identifying a total cost for an order or project including any labor costs, said total cost relating to standard activities performed by, and on behalf of, an enterprise;
custom detail costs operable for identifying expenditures that relate to non-standard activities performed by, and on behalf of, said enterprise; and
miscellaneous costs operable for identifying costs that are not related to said in-place cost factors and said custom detail costs.

4. The method of claim 1, wherein said timeliness driver includes at least one of:
a turnaround time operable for identifying a total time expended between transmitting a general request and receiving a detailed response to said general request;
an advance notice interval operable for identifying an average advance notice given to at least one of an equipment provider and service provider to initiate an activity; and
a completion date met operable for identifying timeliness of completion of activities performed.

5. A storage medium encoded with machine-readable computer program code for providing web-based reporting services to a telecommunications entity, said storage medium including instructions for causing a server to implement a method, comprising:
providing a user interface to a client system in response to a request for a report, said report specifying a report type;
providing a requester with a template only if said requester is authorized to receive said report;
prompting said requester to enter request data in said template;
upon receiving said request data, searching a database for a dataset corresponding to said request data;
if said dataset is found, retrieving at least one order from said database in accordance with a report type requested;
if said dataset is not found, returning an error message to said requester;
retrieving budget data related to said at least one order;
compiling a report using said at least one order and said budget data;
wherein said report includes at least one of a cost driver and a timeliness driver; and
making said report available to said requester over a web-based network;
wherein said report type comprises at least one of:
a cost report;
a timeliness report;
a telecommunication equipment order preparation report;
a driver report; and
a custom search report.

6. The storage medium of claim 5, further comprising instructions for causing said server to implement:
retrieving model-based ordering system data when said report type is a model report; wherein said compiling a report using said at least one order and said budget data includes compiling a report using said model-based order system data.

7. The storage medium of claim 5, wherein said cost driver includes at least one of:
in-place cost factors operable for identifying a total cost for an order or project including any labor costs, said total cost relating to standard activities performed by, and on behalf of, an enterprise;
custom detail costs operable for identifying expenditures that relate to non-standard activities performed by, and on behalf of, said enterprise; and
miscellaneous costs operable for identifying costs that are not related to said in-place cost factors and said custom detail costs.

8. The storage medium of claim 5, wherein said timeliness driver includes at least one of:
a turnaround time operable for identifying a total time expended between transmitting a general request and receiving a detailed response to said general request;
an advance notice interval operable for identifying an average advance notice given to at least one of an equipment provider and service provider to initiate an activity; and
a completion date met operable for identifying timeliness of completion of activities performed.

9. A system for providing web-based reporting services to a telecommunications entity, comprising:
a host system in communication with at least one client system via communications network, said host system comprising a server and a data repository storing databases of budget data and order data;
wherein said server executes web server software, a budget tool, and an ordering tool;
a user interface accessible to said at least one client system, said user interface including templates operable for entering report request data by a user of said at least one client system;
wherein said server performs:
receiving a request for a report, said report specifying a report type;
providing a requester with a template only if said requester is authorized to receive said report;
prompting said requester to enter request data in said template;
upon receiving said request data, searching a database for a dataset corresponding to said request data;
if said dataset is found, retrieving at least one order from said database in accordance with a report type requested;
if said dataset is not found, returning an error message to said requester;
retrieving budget data related to said at least one order;
compiling a report using said at least one order and said budget data;
wherein said report includes at least one of a cost driver and a timeliness driver; and
making said report available to said requester over a web-based network.

10. The system of claim 9, wherein said report type comprises at least one of:
a cost report;
a timeliness report;
a telecommunication equipment order preparation report;
a driver report; and
a custom search report.

11. The system of claim 9, further comprising:
model-based ordering system data stored in said data repository; wherein when said report type is a model report, said server further performs:
retrieving model-based ordering system data; and
compiling a report using said at least one order, said budget data, and said model-based ordering system data.

12. The system of claim 9 wherein said timeliness report includes information relating to overall ordering, engineering, and installation processes that transpire between an enterprise and its vendors and contractors.

13. The system of claim 12, wherein said timeliness driver includes at least one of:
a turnaround time operable for identifying a total time expended between transmitting a general request and receiving a detailed response to said general request;
an advance notice interval operable for identifying an average advance notice given to at least one of an equipment provider and service provider to initiate an activity; and
a completion date met operable for identifying timeliness of completion of activities performed.

14. The system of claim 9, wherein said cost report includes at least one of:
a summary cost report including an average and total for all fields selected in said report request; and
a detail cost report including a line-by-line itemization for each project for all fields selected in the report request.

15. The system of claim 14, wherein said cost driver includes at least one of:
in-place cost factors operable for identifying a total cost for an order or project including any labor costs, said total cost relating to standard activities performed by, and on behalf of, an enterprise;
custom detail costs operable for identifying expenditures that relate to non-standard activities performed by, and on behalf of, said enterprise; and
miscellaneous costs operable for identifying costs that are not related to said in-place cost factors and said custom detail costs.

16. The system of claim 9, wherein said telecommunication equipment order preparation report include overall percentage of projects containing appendices that are billable by vendor during a period of time for review.

17. The system of claim 16, wherein said telecommunications equipment order preparation report further includes fields of data, said fields of data including at least one of:
a supplier code identifying said vendor;
a state;
an order count;
a total number of appendices;
a total number of billable appendices;
a total number of non-billable appendices; and
billable percentage of appendices.

18. The system of claim 9, wherein said driver report includes driver types, said driver types including at least one of:
circuit capacity management primary central office provisioning and maintenance work;
central office space conditioning work;
central office removal work;
work activities for standby engines;
unit cost for miscellaneous non-depreciable material items;
outside plant work for customer premises;
controlled environment vaults;
remote terminals; and
work activities related to power provisioning and maintenance.

19. The system of claim 18, wherein said driver report includes at least one of:
a driver summary report providing model usage at a detailed level by work area; and
an overall driver summary report providing aggregated total model usage during a
requested period of time and related dollar expenditures for a respective driver.
